(19) United States
(12) Patent Application Publication
(10) Pub. No.: US 2005/0174367 A1
(43) Pub. Date: Aug. 11, 2005

(54) Nail art operating method, and apparatus thereof

(76) Inventors: Kazuo Kondo, Tokyo (JP); Kazutsugu Uchida, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 10/626,551

(22) Filed: Jul. 25, 2003

(30) Foreign Application Priority Data
Nov. 1, 2002 (JP) 2002-319935
Feb. 26, 2003 (JP) 2003-48718

(51) Int. Cl. B41J 2/01

(52) U.S. Cl. 347/3

(57) ABSTRACT

The nail art operating apparatus of the present invention is capable of depicting pictorial images with various contents on nails using various colors of inks accurately during short time period without compelling the user to perform onerous operation, and contaminates periphery of the apparatus a little. The nail art operating apparatus is comprised of a fingertip fixation measure 50 for fixing the fingertip on which a nail art is operated, a changer 140 for selecting a printing plate to be used from a plurality of the printing plates, a selector table for selecting a plate surface to be used on the selected printing plate, an ink stage for applying selected ink to the selected plate surface while selecting the ink introduced from a plurality of ink container housed in a container housing section 110, and a printing section 180 for performing printing for the nail in such a way as to re-transcribe the pictorial image to the nail so as to bring this pad into contact with the nail of the fingertip of the user, after transcribing this ink to the pad.

### BACKGROUND OF THE INVENTION

1. Field of the Invention

The present invention relates to a nail art operating method and apparatus thereof. More particularly, the present invention relates to a nail art operating method and apparatus thereof capable of depicting various patterns, graphics or characters with multicolor on a surface of the nails of the user, so that it can be utilized in beauty or entertainment field.

2. Description of the Related Art

Recently, instead of manicure, the nail art is actively pursued. The nail art depicts patterns, graphics or characters on the surface of the nail with multicolor. The nail art is well-practiced especially among young women following improvement in the standard of life as a consumer. The nail art becomes established universally as personal adornment on the beauty from transient boom.

However, the conventional nail art is the professional service which a beauty parlor contributes to the user. For that reason, there are problems for the nail art to be insufficient in the number of the nailists for operating the nail art to the person. And also, it takes long time before completion. Consequently, it sometimes costs very high.

In order for the nail art to settle these problems a number of proposals are provided. These proposals are to print the nail art painting on the nail.

For instance, there is proposed a method that a stencil is placed in contact with the surface of the nail and the method performs the nail art while spurting an ink thereon. (referred to as patent document 1: Japanese Patent Application Laid-Open No. 2001-314226 pp3-8, FIG. 1) Or there is proposed an apparatus for printing the nail art painting while spurting color ink on the nail in such a way as to use ink jet printer along the pictorial pattern stored in the storage section of the memory card and so forth. (referred to as patent document 2: Japanese Patent Application Laid-Open No. 2002-165632 pp2-4, FIG. 1) Or there is proposed an apparatus for enabling the pattern to be printed distinctly while recognizing profile or shape of the nail section using the ink jet printer. (for instance, referred to as patent document 3 and patent document 4: Japanese Patent Application Laid-Open No. 2000-194383 pp2-5, FIG. 1)

However, the printing method of the conventional nail art is of the ink spurting method using the ink jet printer and so forth.

The ink jet printer used as the peripheral devices of the personal computer and so forth has high degree of freedom as the printing apparatus and is capable of printing to select design or color extensively. However, in the ink spurting method, spurting direction of the ink should be placed vertically to the printed surface and clearance between the head for printing and printed surface should be held constant. For that reason, medium for printing is limited to flat surface such as plain paper, card, seal or cloth, thus there is the problem that it is not adequate for the solid body to be printed thereon. Consequently, it is not necessarily adequate for the printed article to be curved surface such as nail. The printing is easy to wash out in curved portion at periphery of the nail. There is the problem that contrivance becomes necessary for the clear printing to be performed. The methods indicated in the patent documents 3, and 4 are not necessarily sufficient measures. Further, there is the problem that when the design protrudes from the profile of the nail in the ink spurting method, the ink is easy to contaminate periphery of the stand for placing the finger. It is no good from the perspective of the beauty for the printing apparatus to be utilized frequently by the member of the public.

On the other hand, there is a pad printing apparatus as an apparatus for printing pictorial image such as characters or patterns.

The pad printing apparatus is provided with the engraved plate surface on which concave portion is formed corresponding to pictorial image for printing. The ink is applied to the engraved plate surface, so that printing is performed in such a way that the ink is transcribed on the printed article by using medium with elasticity for transcribing the ink called as the pad. The pad printing apparatus is capable of printing not only flat surface but also curved surface because such pad is used. The pad printing apparatus has advantage that it is possible to print on the flexible articles (for instance, flutes, or confection or so forth) or brittle articles (for instance, eggs, ceramic works, glass products and so forth) . However, the design printed by this method is limited to the available engraved plate, thus there is the defect that the degree of freedom of the printing is small in comparison with the ink jet printer.

As described above, a large number of conventional method and apparatus for operating nail art adopts the ink spurting system such as the ink jet printer. The printing method of the ink spurting system has advantages that the degree of freedom is large and it is possible to print while selecting color and design freely. However, there are a large number of problems when printing the design on the three-dimensional surface such nail and so forth whose size or shape is different. On the other hand, the pad printing apparatus has advantage that it is possible to print on the three-dimensional surface, however there is the defect that the degree of freedom of the printing is small in comparison with the ink jet printer.

It is an object of the present invention to provide a method and apparatus for operating nail art capable of depicting various pictorial images-on the nail in short time and precisely using various color inks while capitalizing on strengths of the pad printing method and overcoming a fault thereof and to contaminate periphery of the apparatus is relatively small.

According to a first aspect of the present invention, there is provided a nail art operating method which comprises the steps of a fingertip fixation step for fixing the fingertip of the user on a pedestal, and a printing step for printing a picture or a pattern by pad printing method on a nail of said fingertip fixed at said fingertip fixation step.

According to a second aspect of the present invention, in the first aspect, there is provided the nail art operating method, wherein, at the printing step, the printing is performed via plate surface selecting step for selecting the plate surface on which concave section corresponding to printed picture or pattern is formed, an ink applying step for applying ink to the plate surface selected at this plate surface selecting step, a transcribing step for transcribing the ink applied on the concave section of the plate surface on the pad as the transcription surface, and re-transcribing step for re-transcribing the ink transcribed on the pad for the nail at this transcribing step.

According to a third aspect of the present invention, in the second aspect, there is provided the nail art operating method, wherein, at the printing step, different pictures or patterns with different color inks are made to print on the nails upon repeating the plate surface selecting step and the ink applying step.

According to a fourth aspect of the present invention, in the first aspect, there is provided the nail art operating method, wherein the printing step further comprises the steps of an ink jet method applying step for spurting to apply the ink to a first transcription surface according to ink jet method printing, a transcribing step for further transcribing the ink applied on the first transcription surface on the pad to be the second transcription surface at the ink jet method applying step, and a re-transcribing step for further re-transcribing the ink transcribed on the pad for said nail at this transcribing step.

According to a fifth aspect of the present invention, there is provided a nail art operating apparatus which applies an ink to a plate surface on which a concave section is formed, transcribes said ink existing on the concave section of this plate surface, and re-transcribes said ink transcribed on this pad for the nail comprises fingertip fixation means for fixing the fingertip of the user, plate surface selecting means for selecting the plate surface in use from said plurality of plate surfaces, ink applying means for applying the selected ink to the plate surface selected by said plate surface selecting means while selecting said ink introduced from a plurality of ink container for containing said ink, and re-transcribing means for re-transcribing the ink transcribed on the pad for the nail so as to bring this pad into contact with the nail of the user's fingertip fixed on the fingertip fixation means, after transcribing the ink applied on the-plate surface by the ink applying means to the pad.

According to a six aspect of the present invention, in the fifth aspect, there is provided the nail art operating apparatus, wherein the plate surface selecting means further comprises medium mounting means capable of mounting a plurality of plate surface formation medium to be the medium on which the plate surface is formed more than one, and medium taking out means for taking out one plate surface formation medium from among the plate surface formation medium mounted on the medium mounting means, wherein the ink applying means apply the selected ink introduced from the ink container to the plate surface on the plate surface formation medium taken out by the medium taking out means.

According to a seventh aspect of the present invention, in the sixth aspect, there is provided the nail art operating apparatus, wherein when the medium taking out means takes out the plate surface formation medium on which a plurality of the plate surfaces are formed, the printing for the nail is made to perform repeatedly while changing the plate surface used for the printing as needed depending on the taken out plate surface formation medium.

According to an eighth aspect of the present invention, inthe sixth aspect, there is provided the nail art operating apparatus, wherein the plate surface formation medium including part to be of magnetic metal is shifted from the medium mounting means to a table for placing the plate surface formation medium by the medium taking out means, then part to be of the magnetic metal is attracted to be fixed by magnetic line of electromagnet on this table.

According to a ninth aspect of the present invention, in the sixth aspect, there is provided the nail art operating apparatus, wherein the dropping ink due to the ink applying means to the plate surface formation medium fixed on the table is applied by a squeegee.

According to a tenth aspect of the present invention, in the sixth aspect, there is provided the nail art operating apparatus, wherein common shifting means causes the medium taking out means and the re-transcribing means to shift.

According to an eleventh aspect of the present invention, in the fifth aspect, there is provided the nail art operating apparatus, wherein the ink nozzle arrangement position shifts between the ink application position and the rest position on the table because the ink applying means rotates with its rotational axis section to become a fulcrum as the center.

According to a twelfth aspect of the present invention, in the sixth aspect, there is provided the nail art operating apparatus further comprising plate surface cleaning means for cleaning the plate surface formation medium after use.

According to a thirteenth aspect of the present invention, in the twelfth aspect, there is provided the nail art operating apparatus, wherein the plate surface cleaning means and the rotational axis section of the ink applying means occupy identical position reciprocally against the table in use.

According to a fourteenth aspect of the present invention, there is provided a nail art operating apparatus which transcribes an ink applied by an ink jet method printing to a pad, and re-transcribes the ink transcribed to this pad to a nail, comprising fingertip fixation means for fixing the fingertip of the user, ink jet method printing means for spurting to apply the ink to a first transcription surface depending on the ink jet method printing, and re-transcribing means for re-transcribing the ink transcribed to the pad for the nail so as to bring this pad into contact with the nail of the fingertip of the user fixed on the fingertip fixation means, after transcribing the ink applied on the first transcription surface by this ink jet method printing means to the pad to be the second transcription surface.

According to a fifteenth aspect of the present invention, in the fourteenth aspect, there is provided the nail art operating apparatus further comprising control means for controlling the apparatus, and storage means for storing a plurality of art pattern data and color data, wherein the control means specify the printing to the ink jet method printing means based on the art pattern data and color data stored in the storage means.

According to a sixteenth aspect of the present invention, in the fourteenth aspect, there is provided the nail art operating apparatus further comprising specification input means for specifying selection of the art pattern data and color data, and display means for displaying a printed result pattern based on the art pattern data and color data selected by this specification input means.

According to a seventeenth aspect of the present invention, in the fourteenth aspect, there is provided the nail art operating apparatus, wherein the first transcription surface is a role paper with moisture-absorption characteristic and the second transcription surface is the pad.

According to an eighteenth aspect of the present invention, in the fourteenth aspect, there is provided the nail art operating apparatus, wherein the first transcription surface is of material with no capillarity, and the second transcription surface is the pad.

According to a ninth aspect of the present invention, in the fifth aspect, there is provided the nail art operating apparatus, wherein the fingertip fixation means is provided with nail position specification means for determining the position of the nail of the user.

According to a twentieth aspect of the present invention, in the fifth aspect, there is provided the nail art operating apparatus, further comprising cleaning means for cleaning the pad.

According to a twenty-first aspect of the present invention, in the fifth aspect, there is provided the nail art operating apparatus, wherein there is provided accounting operation means causing the apparatus to operate in answer to receiving of coins or paper money or so forth.

Other and further objects and features of the present invention will be become obvious upon understanding of the illustrative embodiments about to be described in connection with the accompanying drawings or will be indicated in the appended claims, and various advantages not referred to herein will occur to one skilled in the art upon employing of the invention in practice.

### BRIEF DESCRIPTION OF THE DRAWINGS

FIG. 1 is an outline view showing the nail art operating apparatus according to the first embodiment of the present invention.

FIG. 2 is a front view showing an apparatus configuration of the nail art operating apparatus according to the first embodiment of the present invention.

FIG. 3 is a side view showing an apparatus configuration of the nail art operating apparatus according to the first embodiment of the present invention.

FIG. 4 is a plan view showing an apparatus configuration of the nail art operating apparatus according to the first embodiment of the present invention.

FIG. 5 is an explanatory view showing configuration of a fingertip fixation means in the present invention.

FIG. 6 is an explanatory view showing a selector table and printing plate set thereon in the first embodiment of the present invention.

FIG. 7 is an explanatory view showing an example of a forming plate surface of the printing plate shape.

FIG. 8 is an explanatory view showing a configuration and an operation of an ink stage in the first embodiment of the present invention.

FIG. 9 is an explanatory view showing a configuration and an operation of a cleaning section in the first embodiment of the present invention.

FIG. 10 is a plan view showing an apparatus configuration of the nail art operating apparatus according to the second embodiment of the present invention.

FIG. 11 is a plan view showing an apparatus configuration of the nail art operating apparatus according to the second embodiment of the present invention.

FIG. 12 is a side view showing an apparatus configuration of the nail art operating means according to the second embodiment of the present invention.

FIG. 13 is an outline view showing a printing apparatus according to the third embodiment of the present invention.

FIG. 14 is a front view showing an apparatus configuration of a printing apparatus according to the third embodiment of the present invention.

FIG. 15 is a side view showing an apparatus configuration of a printing apparatus according to the third embodiment of the present invention.

FIG. 16 is a plan view showing an apparatus configuration of a printing apparatus according to the third embodiment of the present invention.

FIG. 17 is an explanatory view showing a configuration of a role paper feeding apparatus in the third embodiment of the present invention.

FIG. 18 is a circuit block diagram of the nail art operating apparatus of the present invention.

### DETAILED DESCRIPTION OF THE PREFERRED EMBODIMENTS

There will be described the first embodiment of the nail art operating apparatus of the present invention in detail referring to accompanying drawings below.

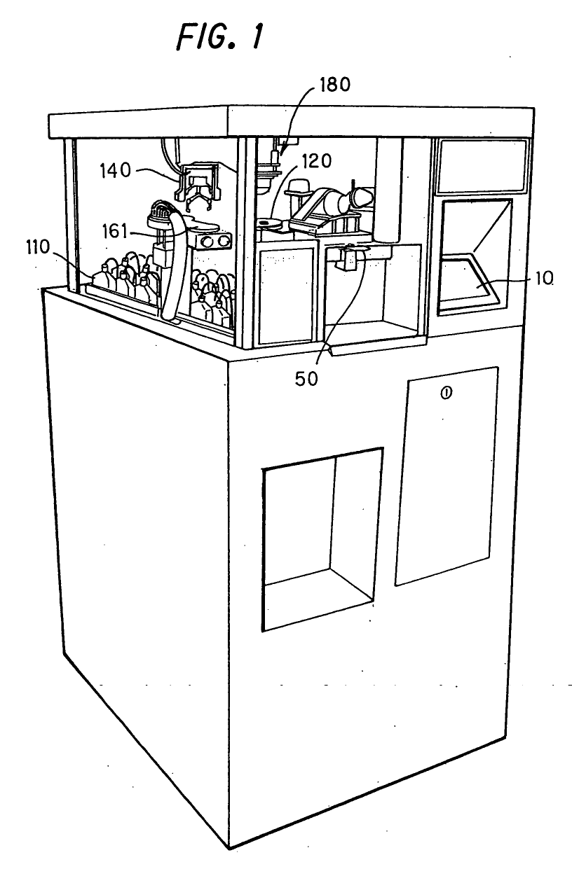

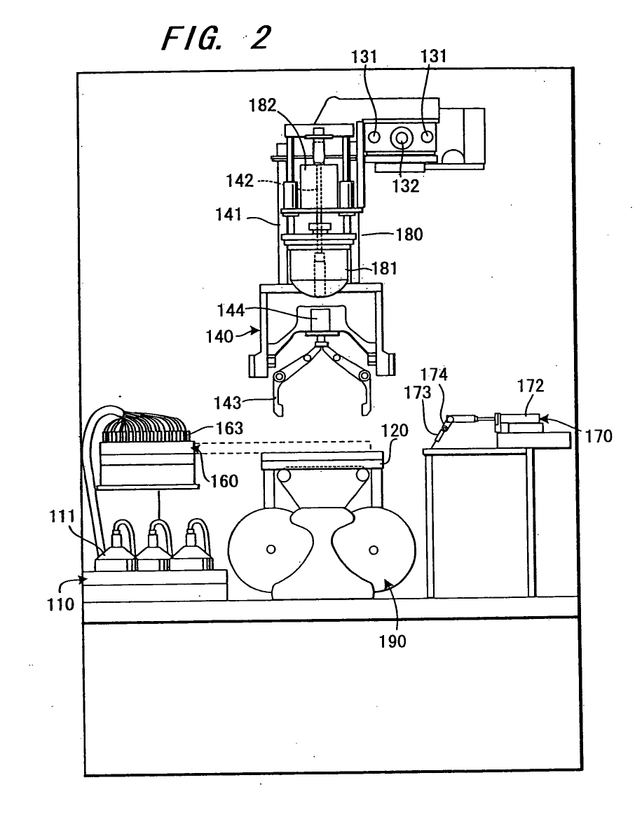

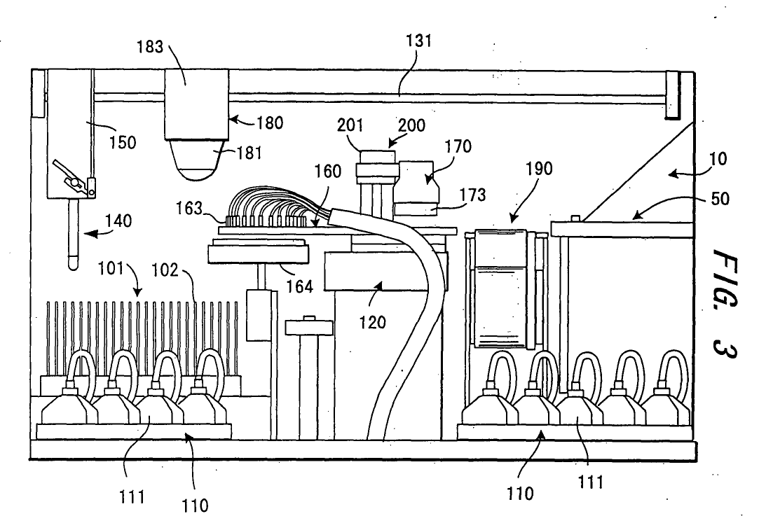

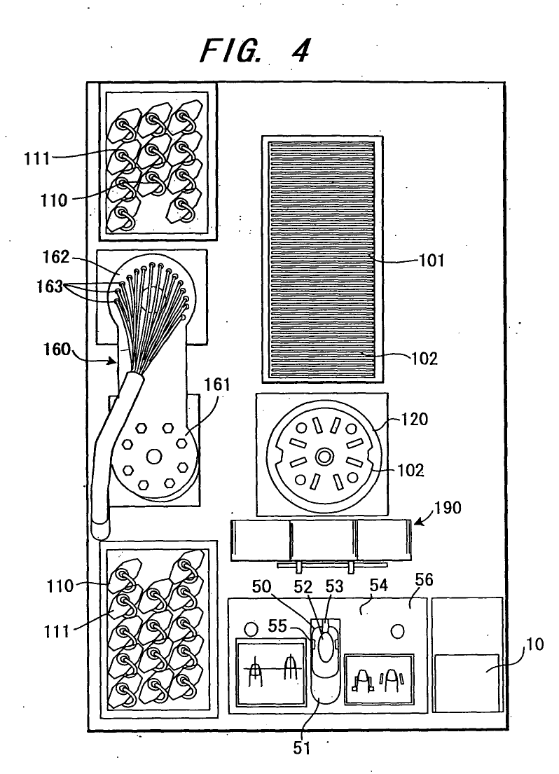

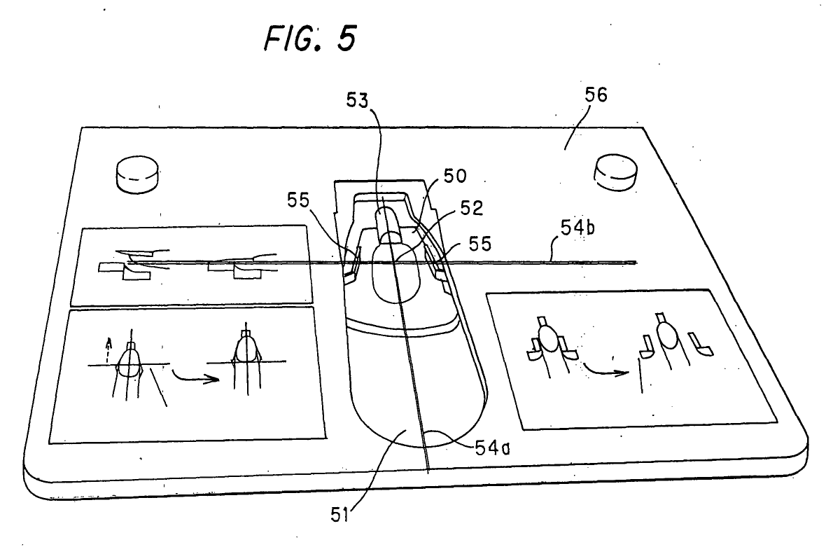

FIG. 1 is an outline view showing the nail art operating apparatus according to the first embodiment. FIG. 2 is a front view showing an apparatus configuration of the nail art operating apparatus according to the present embodiment. FIG. 3 is a side view showing an apparatus configuration of the nail art operating apparatus according to the present embodiment. FIG. 4 is a plan view showing an apparatus configuration of the nail art operating apparatus according to the first embodiment. It should be noted that FIGS. 2, 3 and 4 show the apparatus while omitting parts thereof. FIG. 5 is a perspective view showing a fingertip fixation means.

The nail art operating apparatus of the present embodiment is provided with a touch panel apparatus 10 and a fingertip fixation means 50 in front thereof as shown in the outline view of FIG. 1. The operation from the touch panel apparatus 10 performs the nail art on the nail of the finger set on the fingertip fixation means 50. Examples of the patterns or the color samples which are capable of being used as the nail art are shown in front of the apparatus. The user who is subjected to the operation of the nail art can observe mechanical configuration and operation of the apparatus, so that the operation attracts interest of the user.

There will be explained operation of the nail art operating means of the present embodiment in the order of events.

Firstly, function of the fingertip fixation means will be made to explain. In FIG. 5, the fingertip fixation means 50 is comprised of a fingertip placement stand 52 and a nail-tip placement section 53 movable backwards and forwards, a nail center position indicating light 54a and a nail rear end position indicating light 54b emitted from red laser light source not illustrated for determining position of the nail, a finger clip 55 for interposing to fix the fingertip be in operation, a table 56, and a wrist insertion slot 51 provided to fix the finger on the fingertip placement stand 52 in such a way that the wrist is inserted into the wrist insertion slot 51 upwards below the table 56. Furthermore, the rubric of fixing method of the nail to this fingertip fixation means 50 and operating instructions of the apparatus is written on the table 56. Moreover, the touch panel apparatus 10 is provided bordered by this fingertip fixation means 50, so that the user is capable of operating the apparatus using this touch panel apparatus 10.

There will be explained operation of this fingertip fixation means 50. The user selects to specify picture or pattern for printing and color thereof from the touch panel apparatus 10 And then, the user inserts his hand into the wrist insertion slot 51, places the fingertip to be a subject of operation on the fingertip placement stand 52, and further places nail-tip on the nail-tip placement stand 53. Under this condition, the fingertip placement stand 52 is made to shift backwards and forwards, so that the nail center position indicating light 54a coincides with longitudinal center of the nail and the nail rear end position indicating light 54b coincides with boundary between rear end portion of the nail and the cuticle. According to this adjustment, it is possible to place the nail on the optimum printing position.

Under this condition, the user inputs set completion in such a way as to press a set OK button from the touch panel apparatus 10, so that the finger clip 55 closes to fix the fingertip while holding the fingertip from right and left. The finger clip 55 closes, so that approximate width of the nail is taken in the apparatus. The nail art printing to the nail begins. When the printing of the specified picture or pattern is terminated, the finger clip 55 opens to leave open the finger.

Next, there will be explained implementation method of the nail art printing of the present embodiment. A numeral 101 in FIG. 3 and FIG. 4 indicates a placement stand for placing a plate surface forming medium (hereinafter referred to as printing plate) 102 with circular shape having a plurality of the plate surfaces in which concave section in accordance with pictorial image is formed. As shown in FIGS. 3 and 4, a large number of the printing plates 102 are placed to be arranged lengthwise on the placement stand 101. It should be noted that the printing plate 102 is provided with a part made of magnetic metal which is attracted by lines of magnetic force. For instance, iron plate is embedded within the printing plate 102.

A numeral 110 in FIGS. 2, 3 and 4 indicates a container housing section capable of housing a plurality of ink containers 111 in which ink is contained. As shown in FIG. 3, the container housing section 110 is capable of housing the ink container 111 up to 24.

The present embodiment prepares the placement stand 101 and the container housing section 110. One of the printing plates 102 placed on the placement stand 101 is taken out. This printing plate 102 is set on the selector table 120. The ink is drawn out via an ink tube from the ink container 111 of the container housing section 110. The ink is selected and applied to the plate surface on the printing plate 102 set to this table 120. Thus printing to the nail of the fingertip fixed to the fingertip fixation means 50 is performed in such a way as to use the printing plate 102. Here, the ink is of water-soluble one.

In the present embodiment, both of the plate surface and the ink for applying the plate surface are capable of being selected and changed automatically. Therefore, the user of the nail art operating apparatus is not necessary to perform special operation at the time the user changes contents (design, or color, or so forth) of the pictorial image for printing.

For instance, it is not necessary for the user to change the plate surface or the ink, for this reason, it is always possible to perform the nail art printing easily the pictorial image with various contents.

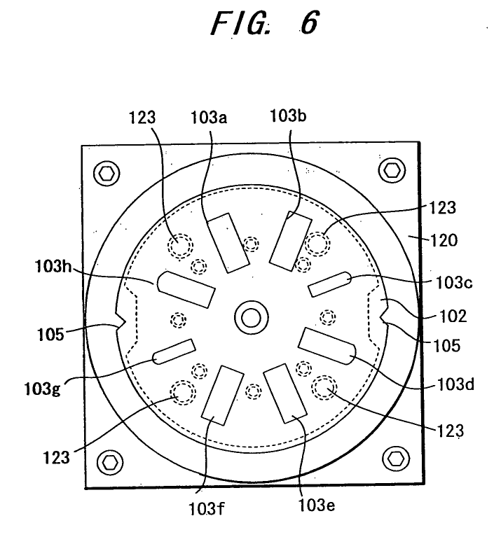

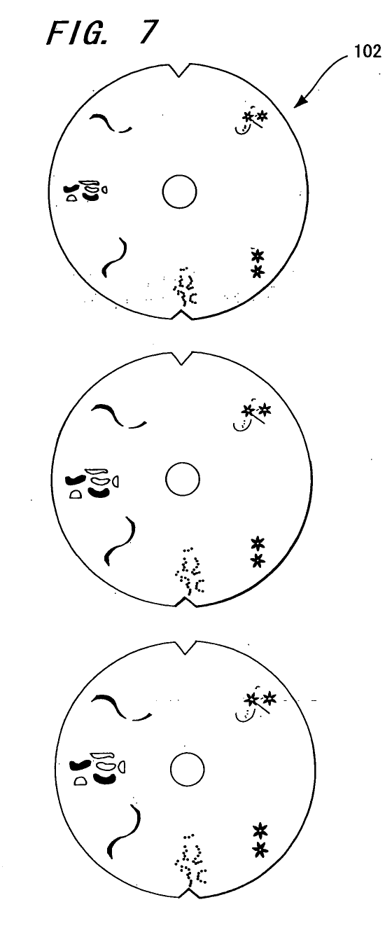

FIG. 6 shows condition in which the printing plate 102 is set on the selector table 120. Further, FIG. 7 shows a practical example of the plate surface 103 provided on the printing plate 102. On the above printing plate 102, as shown in FIG. 6, for instance, total 8 plate surfaces indicated by 103a to 103h are formed and arranged on the circumference. Two notches 105 are formed on the periphery. The segment in which the plate surface 103 is formed is made of resin. The magnetic metal such as the iron plate is embedded in the rear side thereof. The printing plate 102 with the shape and the configuration is set on the selector table 120. The selector table 120 is capable of being rotated within the predetermined angle. A plurality of plate surfaces 103 are arranged on the circumference so that the plate surface 103 used for the printing is capable of being selected and changed in due order by using rotation of this selector table 120. It is preferable that a plurality of plate surfaces 103 in the same pattern should be prepared in accordance with width or length of the finger as shown in FIG. 7.

The selector table 120 is provided with projections not illustrated in accordance with position or shape of the notch 105 formed on the printing plate 102. The printing plate 102 is set with accuracy on the table 120 using this notch 105 and the projection. In addition, in order to hold the set printing plate 102 surely, 4 electromagnets 123 are arranged so that the printing plate 102 is fixed by the magnetic force.

Projections fitted to the shape of the above notch 105 are also provided at the placement stand 101. According to the projections, the printing plate 102 is placed on the placement stand 101 in the predetermined condition, so that operation for setting the printing plate 102 taken out from the placement stand 101 on the selector table 120 is carried out simply.

A changer 140 implements shifting of the printing plate 102 placed on the placement stand 101 or the selector table 120, namely, both shifting means shifting from the placement stand 101 to the selector table 120, or shifting from the selector table 120 to the placement stand 101.

The changer 140 has a configuration in which 2 shafts 141 and cylinder 142 support hand section 141 for grasping the printing plate 102. The cylinder 142 is one which is of the type with 2 ports. According to this configuration, shifting in the direction of up and down of the hand section 143 is capable of being performed by using the cylinder 142.

The hand section 143 grasps the printing plate 102 in such a way as to interpose the printing plate 102 between two members to which source of power is transferred with the cylinder 144 as source of power. In order to implement the grasping surely, 2 notches 105 formed on the printing plate 102 are utilized.

The printing plate 102 stands on the placement stand 101, while it lays down on the selector table 120. Here, detailed explanation is omitted. The cylinder (not illustrated) provided at the hand section 143 copes with difference in condition in such a way as to push the hand section down 90 degree.

The changer 140 is capable of shifting along 2 shafts 131 and a screw rod 132 used in common with a printing section 180 described later illustrated in FIGS. 2 and 3 by a shifting section 150. The shifting section 150 folds 2 shafts 131 and the screw rod 132 with the threads. The changer 140 is mounted on the shifting section 150. The power is transferred to the screw rod 132 from the motor not illustrated. By this means, the changer 140 is capable of reciprocating in cross direction of the apparatus.

The shifting of the printing plate 102 according to the changer 140 is implemented as follows: generally, the changer 140 is placed upwards the placement stand 101. In the shifting from the placement stand 101 to the selector table 120, firstly, for instance, the hand section 143 is made to shift to the position where it is possible to grasp the printing plate 102 should be taken out from the placement stand 101. After shifting, driving of the cylinder 142 let the hand section 143 drop downwards. Drive of the cylinder 144 causes the printing plate 102 to grasp by the hand section 143. After grasping, the drive of the cylinder 142 causes the hand section 143 to rise and rotate. Under rotated condition, the changer 140 is made to shift to the position of the selector table 120.

When the changer 140 is shifted to the selector table 120, the drive of the cylinder 142 let the hand section 143 drop in order to set the printing plate 102 on the table 120, then the grasping of the printing plate 102 is made to release at the predetermined timing. At this time, the electromagnet 123 arranged at the table 120 is made to turn on electricity so as to generate magnetic force. After releasing of grasping of the printing plate 102, the hand section is made to rise and rotate to return to its original state, and the changer 140 is shifted above the placement stand 101. By this means, the changer 140 is made to return to regular position while terminating a series of operation.

On the other hand, as to shifting from the selector table 120 to the placement stand 101, firstly, the changer 140 is made to shift to the position above the selector table 120, next, the hand section 143 is made to rotate. The hand section 143 is lowered to the position where it is possible to grasp the printing plate 102 on the table 120 with the rotated state maintained, then, the printing plate 102 is made to grasp while driving the cylinder 144. For instance, at this time, turning on electricity to the electromagnet 123 is released.

After grasping of the printing plate 102, the hand section 143 is made to rise and rotate to make the printing plate 102 standing state. The changer 140 is made to shift to the position above the placement stand 101 with this state maintained, before the hand section 143 is lowered downwards to the position for releasing the printing plate 102 in order to place the printing plate 102 on the placement stand 101 to release it. Then, the hand section 143 is made to rise. By this means, the changer 140 is made to return to the regular position while terminating a series of operation.

It should be noted that for instance, the position of the printing plate 102 placing on the placement stand 101 is predetermined in every printing plate 102. By this means, taking out of the necessary printing plate 102 from the placement stand 101 or housing of the printing plate 102 to the placement stand 101 are performed automatically.

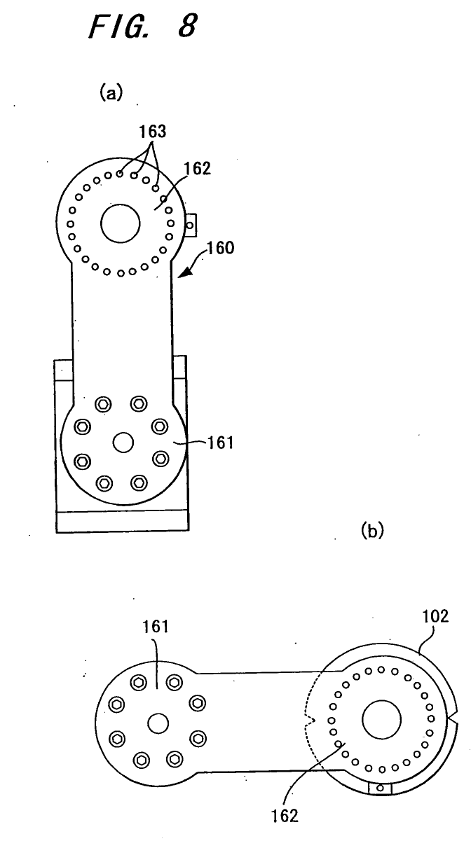

An ink stage 160 pours the ink into the plate surface 103 of the printing plate 102 set on the selector table 120 by the above changer 140. FIG. 8 shows a plan view of the ink stage 160. FIG. 8(b) shows a state of the rest position, and FIG. 8(b) shows a state in which the ink is supplied to the printing plate 102 on the selector table 120.

As shown in FIG. 8, the ink stage 160 is dumbbell shape in which two discs constituting a rotational axis section 161 and nozzle arrangement section 162 are coupled by using arm. The nozzle arrangement section 162 shifts between the rest position and operation position on the selector table 120 while rotating by 90° according to function of rotational mechanism provided under the rotational axis section 161. The nozzle arrangement section 162 arranges 24 nozzles 163 on the circumference thereof in such a way as to arrange in every 15° with even angle. The ink is supplied directly to each nozzle 163 from the 24 ink containers 111 of the container housing section 110 via the ink tube. Each nozzle 163 stays over the sponge placed in a dish section 164 at the rest position of the ink stage 160. The surface of sponge is covered by silicone film. By this means, it is possible to closes up tip of the nozzle 163, so that it is possible to prevent ink leakage from the nozzle 163.

An operation of supplying the ink to the plate surface 103 of the printing plate 102 is performed as follows. Firstly, the printing plate 102 with required plate surface 103 is made to place on the selector table 120. With the state maintained, the ink stage 160 is made to shift on the printing plate 102 on the selector table 120 to be the operating position. And then, the selector table 120 is made to rotate so that the nozzle 163 of the ink with required color arrives on the required plate surface 103. The center of the plate surface 103 is arranged on the printing plate 102 with interval of 45°, and 24 ink nozzles 163 are arranged on the circumference of the nozzle arranging section 162 with the same angle of 15°. The position of the plate surface 103 corresponding to the nail art pattern and the position of the nozzle corresponding to the color of the ink are converted into rotation angle of the selector table beforehand. Therefore, it is possible that the nozzle 163 with required ink arrives on the required plate surface 103 upon shifting the selector table 120 by unit of 15°. When discharging required ink from the nozzle 163 with the state maintained, it is possible to supply the ink with required color to the required plate surface 103. The ink container 111 adopts a configuration in which the air presses the ink container 111 from its upper portion, so that the ink is discharged from the corresponding nozzle 163 of the nozzle arranging section 162 in accordance with the pressure.

It should be noted that similar to the printing plate 102, the position of the ink container 111 contained in the container housing section 110 is determined previously in every ink container 111. By this means, it is possible to perform filling of the air, which means selection of color of the ink, into necessary ink container 111 in the container housing section 110 automatically.

Meanwhile, fat should be made to eliminate from the ink flowing in the plate surface 103. A squeegee 170 performs elimination of fat.

As shown in FIG. 3, the squeegee 170 is provided with a cylinder not shown for shifting the squeegee 170 in the horizontal direction and a blade 173 for eliminating additional ink from an angle adjusting cylinder 172 and the plate surface 103. The cylinder 172 is one which adjusts angle of the blade 173 or position thereof on the vertical direction.

The blade 173 is mounted on end of a member rotating with a fulcrum 174 as an axis. A shaft of the cylinder 172 is linked to another end of the member. The type of the cylinder 172 is that generally, force of an elastic member houses the shaft into the internal section, and the shaft is made to operate in external section in operation. By this means, when driving the cylinder 172, the shaft is pushed out of the internal section, and the blade 173 is rotated with the fulcrum 174 as the axis with the result that the blade 173 comes into contact with the printing plate 102.

Drive of the cylinder 172 shifts the blade 173 to the vicinity of center of the plate surface 103 and shifts the blade 173 from the vicinity of this center to the outer side. By this means, the blade 173 eliminates the ink in such a way as to scrape the ink off the plate surface 103 while facing the blade 173 toward outside from the vicinity of the center.

The blade 173 shifted from the vicinity of the center to the outside is subjected to cleaning in such a way that adhered ink is scraped every single sided by a cleaning blade not shown. The squeegee 170 is capable of always operating in that the both surfaces are maintained in the cleaned state.

As described above, a printing is performed to the article to be printed using a printing section 180, after eliminating additional ink of the plate surface 103 by the squeegee 170.

As shown in FIG. 2, the printing section 180 causes the cylinder 182 to perform up and down movement of the pad 181. A part (hereinafter called as printing execution section) comprised of the pad 181, the cylinder 182 and periphery thereof is supported by 2 shafts 131 and the screw rod 132. These shafts 131, screw rod 132 are used in common with the changer 140. The power is transferred to the screw rod 132 from a motor not shown. The pad 181 is capable of reciprocating between the selector table 120 and the fingertip fixation means 50. As shown in FIG. 3, this printing execution section is generally housed in the case 183.

The printing to the nail placed on the fingertip fixation means 50 by the printing section 180 described above is performed in such a way as described later.

Generally, the pad 181 is positioned above the cleaning section 190. The squeegee 170 removes additional ink of the plate surface 103. Then the pad 181 is made to shift above the plate surface 103, before driving the cylinder 182 during predetermined time. By this means, the pad 181 is made to perform up and down movement. Causing the pad 181 to come into contact with the plate surface 103, the ink which rests on concave section of the plate surface 103 is made to transfer to the pad 181.

The ink of the plate surface 103 is made to transfer to the pad 181, before the pad 181 is made to shift above the fingertip fixation means 50. The pad 181 is made to perform up and down movement again, upon driving the cylinder 182 above the fingertip fixation means 50 again during predetermined time. By this means, it is possible to perform the printing upon re-transferring the ink, which is transferred to the pad 181 once, to the nail placed on the fingertip fixation means 50. After performing printing in such a way as above, the pad 181 is made to shift above the cleaning section 190 to restore to regular position.

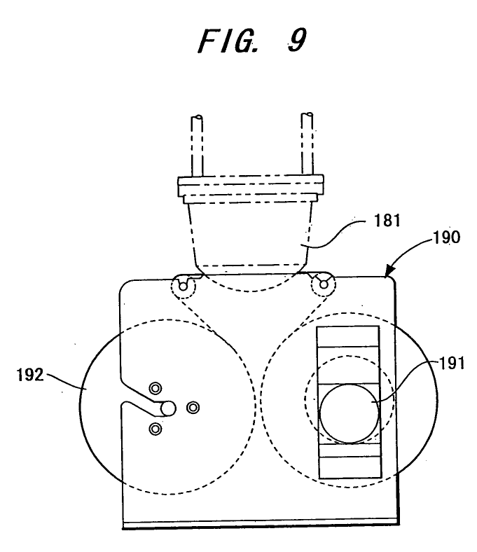

The cleaning section 190 removes rubbishes, dusts adhered to the pad 181 or remaining ink on the pad 181. As shown in FIG. 9, the cleaning section 190 has a configuration in which a roller to which motive power is transmitted from the motor 191 winds tapes drawn from wound tape 192 with adhesive tape wound. Parts of the tape drawn from the wound tape 192 are exposed at the upper part while turning the surface with adhesiveness of the tape toward upward. By this means, the pad 181 is subjected to the up and down movement in the state that the pad 181 is positioned above the cleaning section 190. And then, the surface of the pad 181 comes into contact with the surface with adhesiveness of the tape. Thus, it is possible to remove a foreign body adhered to the surface and remaining ink by adhesiveness of the tape.

It should be noted that the cleaning of the pad 181 using the cleaning section 190 is performed under the predetermined timing. The timing is that application of power is performed, the printing of predetermined number of times is performed or at the time the operator performs special instruction. The cleaning of the pad 181 is capable of being performed automatically upon preparing the cleaning section 190 for performing cleaning of the pad 181. By this means, it is possible to perform automatic operation of the apparatus over an extended time period.

It should be noted that the used printing plate 102 is cleaned up on the selector table 120 by a printing plate cleaning apparatus 200, before returning to the placement stand 101 by using the changer 140. The printing plate cleaning apparatus 200 is comprised of a cylinder not shown for shifting the apparatus in the horizontal direction, brush not shown provided at the tip of the apparatus, a motor 201 for rotating the brush, a cylinder not shown for performing up and down movement of the brush, and dish section for supplying moisture to the brush at rest position. At the time, the printing of the printing section 180 is executed for the nail placed on the fingertip fixation means 50, the printing plate cleaning apparatus 200 is capable of cleaning up remaining additional ink on the printing plate 102 upon rotating the brush on the printing plate 102 placed on the selector table 120.

At this time, in some cases, the moisture remains on the printing plate 102, it is preferable that when repeating the same printing plate 102, the moisture is made to blow out by using air blow.

The present apparatus can be provided with a fare receiving apparatus. The fare receiving apparatus may be regular one which can receive coin or paper money. For instance, insertion of coin or paper money is made to urge at the stage to set the finger, and the charge is collected in such a way as to adopt a method to receive a sum of money corresponding to the number of fingers to which the nail art is given after operation.

The printing of the art pattern for the nail of the user according to the above configuration is performed totally in such a way as below.

Firstly, the user selects picture or pattern of the art pattern and its color for printing to the nail from the samples of the nail art pattern indicated on surface panel of the apparatus or the samples indicated on presentation of the display of the touch panel apparatus 10. When the contents to print are determined, its art pattern number and color number are input from the touch panel apparatus 10. And then, the nail is set on the fingertip fixation means 50 while dropping the coin into the fare deceiving apparatus, the set OK button is made to press of the touch panel apparatus 10.

The apparatus the printing plate 102 takes the printing plate 102 including the specified art pattern out from the printing plates 102 placed on the placement stand 101. The printing plate 102 is made to set. The plate surface 103 for use in the printing is selected among the printing plate 102 while rotating the table 120. The selected plate surface 103 is made to set under the nozzle 163 of the selected color. The ink is made to flow for the corresponding plate surface 103. The squeegee 170 performs elimination of the additional ink. The ink of the plate surface 103 is made to transcribe for the nail via the pad 181. The printing is performed in this order. This printing is terminated. The printing plate 102 set on the selector table 120 is returned to the placement stand 101. The plate surface to use the next printing is selected. The printing using the selected plate surface 103 is performed in the same way as above. This is repeated. The apparatus waits ready until next printing is specified while terminating operation of the printing. It should be noted that when the ink is protruded from the nail and is adhered to part of the finger, it is possible to wipe the protruded ink by a cleaning swab with water. In addition, it is possible to prevent that the ink comes off upon applying topcoat on the nail when the nail art is terminated.

Next, there will be explained the nail art operating apparatus of the second embodiment of the present invention.

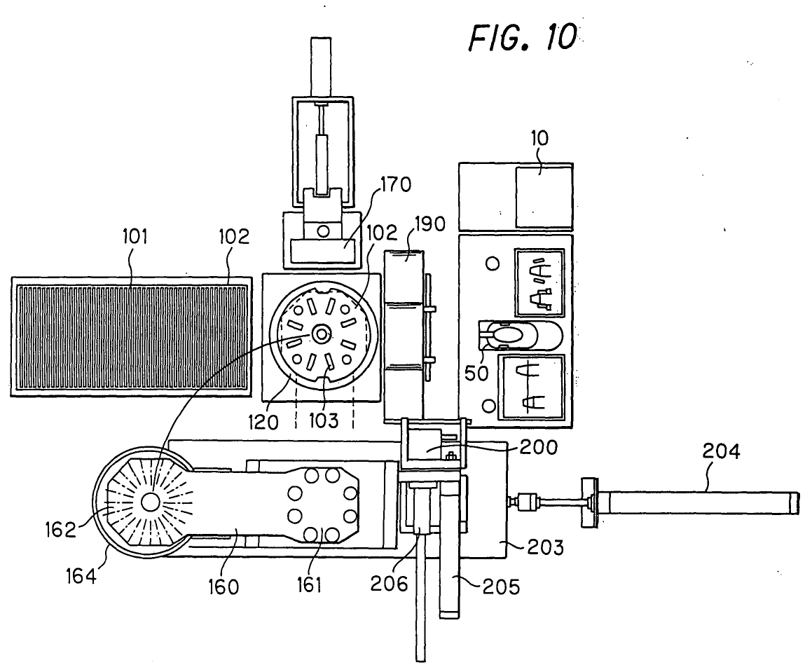

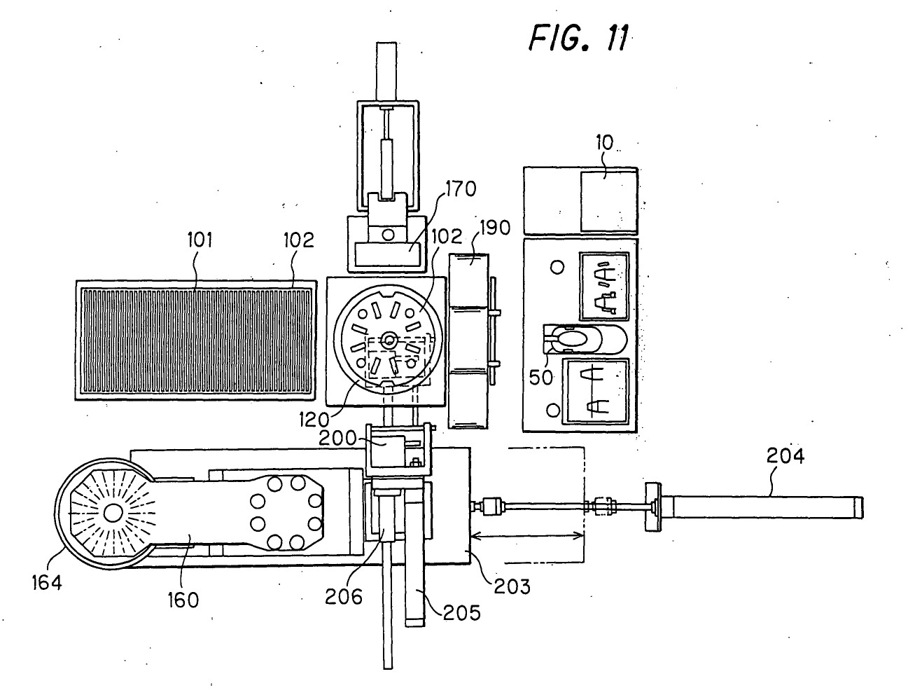

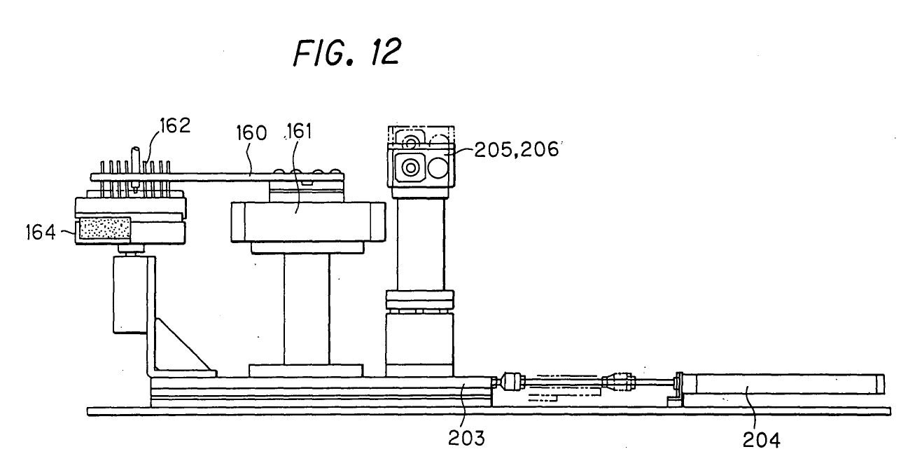

FIG. 10 is a plan view immediately before ink supplying to the plate surface of the nail art operating apparatus of the present embodiment. FIG. 11 is a plan view immediately before plate surface cleaning of the nail art operating apparatus of the present embodiment. FIG. 12 is a side view showing an apparatus configuration of the nail art operating apparatus of the present embodiment. In FIGS. 10 to 12, the same components or the components with the same function as those shown in FIGS. 1 to 9 are indicated using the same signs for simplification.

The operation of the present embodiment is the same as that of the first embodiment described above fundamentally.

In FIGS. 10, 11 and 12, like the above described embodiment, the plate surface 102 is housed in the placement stand 101. The necessary one among them is selected. The selected one is taken by the changer not shown and placed on the selector table 120. In FIG. 10, each nozzle of the nozzle arrangement section 162 of the ink stage 160 is sleeping on the sponge of the dish section 164. The nozzle arrangement section 162 is rotated by 90° with the rotational axis section 161 as the center from this state, by this means, the nozzle arrangement section 162 is placed on the selector table 120, so that the ink from a plurality of ink container not shown provided at underneath of the apparatus is applied to the plate surface 103 of the printing plate 102 on the selector table 120. Additional amount of the ink among the ink applied to the plate surface 103 is scraped by the squeegee 170.

The pad not shown is cleaned up while being pressed against the pad cleaning section 190, then is pressed to the plate surface 103 to which the ink is applied. The ink of the plate surface 103 is transcribed to the pad, after that, the pad is pressed to the nail placed on the fingertip fixation means 50 to re-transcribe the ink. The fingertip fixation means 50 is approximately the same as that shown in FIG. 5. By this means, the printing of the pattern to the nail is performed. When the printing is terminated, the pad is pressed against the pad cleaning section 190 again to be cleaned up. On the other hand, the used plate surface 103 is shifted to the cleaning position by rotation of the selector table, and the plate surface 103 is subjected to cleaning by the printing plate cleaning apparatus 200.

In the present embodiment, the ink stage 160 and the printing plate cleaning apparatus 200 are placed on the same mounting base 203. The mounting base 203 is shifted between the state of FIG. 10 and the state of FIG. 11 by the cylinder 204. During period of the time printing for the nail by the pad is performed, the state is shifted to the state of FIG. 11 by operation of the cylinder 204, while at the state of FIG. 10, the printing plate cleaning apparatus 200 is shifted to position where the rotational axis section 161 of the ink stage 160 occupies. At this position, the printing plate cleaning apparatus 200 shifts on the plate surface 103 of the printing plate 102 placed on the cleaning position on the selector table 120 by the cylinder 205 and the linear push 206. The water is made to spurt to the printing plate 102. The printing plate cleaning apparatus 200 scrapes the printing plate 102 by the brush. Further, the printing plate cleaning apparatus 200 cleans up the printing plate 102 while blowing the moisture by the air blow.

This embodiment differs from the above described first embodiment. Different points are as follows. The ink container is housed under the working table. As described above, the rotational axis section 161 of the ink stage 160 and the printing plate cleaning apparatus 200 are capable of occupying the same position mutually while sliding each other. Therefore, the work is capable of being performed from the position close to the printing plate 102 on the selector table 120. Movement span becomes small. The cleaning of the plate surface 103 is capable of being executed with little time during printing for the nail by the printing section 180. By this means, it is possible to reduce the whole tact time necessary for the nail art operation than the first embodiment, so that it is possible to form the whole apparatus into miniaturized one.

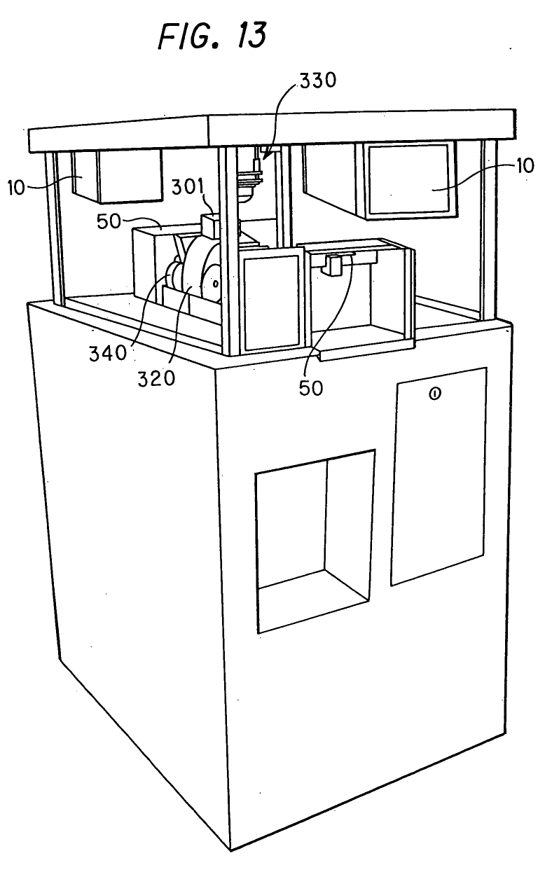

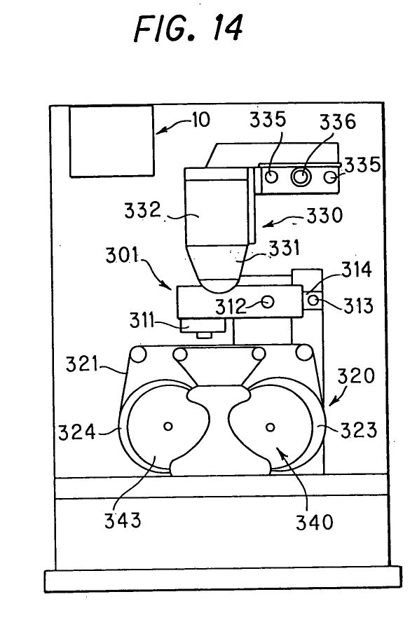

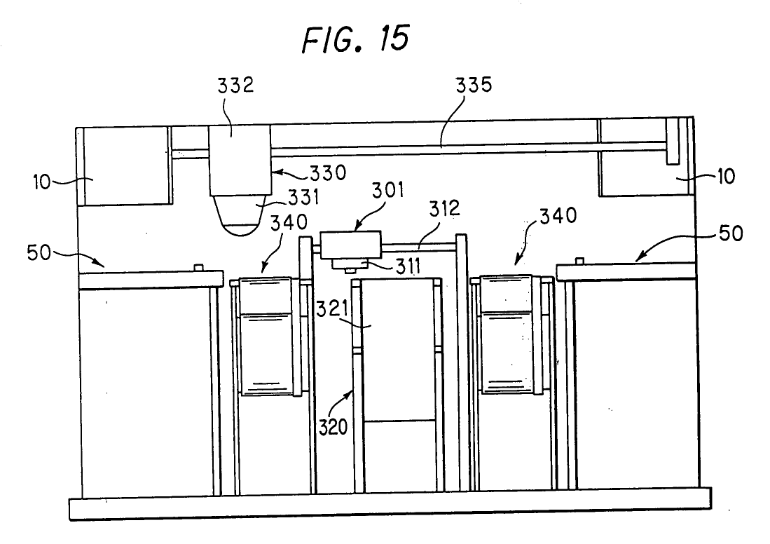

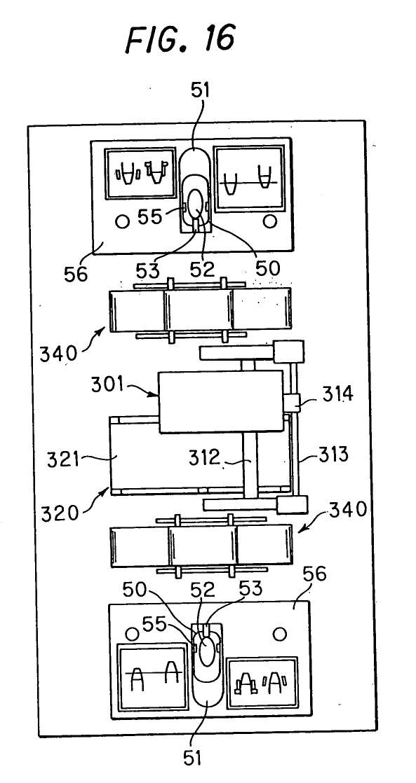

Next, there will be explained the third embodiment of the nail art operating apparatus of the present invention. FIG. 13 is an outline view showing a printing apparatus according to the third embodiment. FIG. 14 is a front view showing an apparatus configuration of a printing apparatus according to the third embodiment. FIG. 15 is a side view showing an apparatus configuration of a printing apparatus according to the third embodiment. FIG. 16 is a plan view showing an apparatus configuration of a printing apparatus according to the third embodiment. In FIGS. 13 to 16, parts among fundamental components are shown while adding the same sign as that shown in FIGS. 1 to 12 for simplification. It should be noted that in FIGS. 14, 15 and 16, part is omitted.

As shown in outline view of FIG. 13, the nail art operating apparatus of the present embodiment is provided with the touch panel apparatus 10 and the fingertip fixation means 50 at 2 positions of front side and rear side thereof. The nail art printing are capable of operating to 2 persons simultaneously for the nail of the finger set to the fingertip fixation means 50 by operation from the touch panel apparatus 10. The operating method of the apparatus, example of the pattern capable of using as the nail art, and sample of the color and so forth are displayed at POP, samples provided at front and rear section or the monitor of the touch panel apparatus 10. The user who is subjected to the operation of the nail art can observe mechanical configuration and operation of the apparatus, so that the operation attracts interest of the user.

There will be explained operation of the nail art operating means of the present embodiment in the order of events.

The fingertip fixation means 50 is capable of being utilized approximately the same one as that explained in FIG. 5 and its operation is also approximately the same as that described above, therefore explanation is not performed here.

The touch panel apparatus 10 is provided above the fingertip fixation means 50. The user is capable of performing selection of operation of the apparatus and operating the apparatus using the touch panel apparatus 10.

Next, there will be explained operation of the nail art operating apparatus of the present embodiment.

The printing for the nail of the finger placed on the fingertip fixation means 50 of the nail art operating apparatus is performed via 2 stages of formation of the nail art pattern by the ink jet printer and transcription for the nail via the pad of the prepared pattern.

FIG. 14, 15, and 16 show the ink jet printer 301. The ink jet printer 301 is controlled by a control apparatus not shown. The control apparatus prints the nail art pattern specified by the user via the touch panel apparatus 10 on role paper 321 of role paper providing apparatus 320 to be the first transcription surface. Contents such as various patterns or designs constituting the nail art patterns to be printed are, for instance, stored in a memory of the control apparatus. The contents are read out according to control of the control apparatus based on specification from the touch panel apparatus 10 by the user. Printing result is shown via display of the touch panel to the user. After that, when printing contents are decided by agreement of the user, its pattern data and color data are transmitted to the ink jet printer 301. The memory memorizes plural kinds of contents, and transmits selected contents to the control circuit in accordance with the read out specification of the control circuit. The memory is of, arbitrary storage means such as for instance, floppy disc, hard disc, CD-ROM, flash memory.

The ink jet printer performs printing in such a way as to spray grain shaped ink with electrical charge from a nozzle. Kind of the ink is of CMYK (cyan, magenta, yellow, black) or CMYW (cyan, magenta, yellow, white). By combination of these inks, it is possible to express delicate variation of the color, and it is possible to reappear limitless color. The ink jet printer 301 prints the nail art pattern to be of combination of the specified contents on the role paper 321 to be the first transcription surface.

The ink jet printer 301 is supported by the shaft 312 and the screw rod 313. The power is transmitted to the screw rod 313 form a motor not shown. The screw rod 313 is rotated. The ink jet printer 312 shifts in the rectangular direction to the winding direction of the role paper 321 upon receiving this rotation by the gear 314. It is possible to depict two-dimensional art pattern by rotation of this screw rod 313 and winding of the role paper 321. Further, it is possible to depict fine pattern in high speed in such a way that a head section 311 shifts on the role paper 321 and depicts the art pattern against the ink jet printer 301 main body.

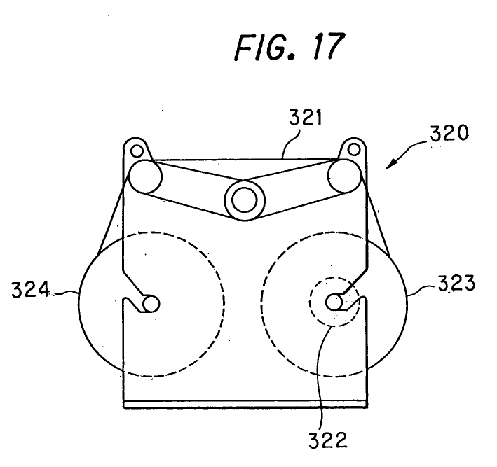

FIG. 17 is a constitution view of the role paper providing apparatus of the present embodiment. As shown in FIG. 17, the role paper 321 uses reel 323 to which power is transmitted from the motor 322. The paper is wound by the reel 323 drawn out from the role 24 to which paper tape with good moisture-absorption characteristic is wound.

This role paper 321 has characteristic to absorb moisture from the printing ink of the printed pattern by the ink jet printer 301. Generally, the ink used for the ink jet printer 301 includes a somewhat larger quantity of moisture to prevent clogging at the time of spurting of the ink from the fine nozzles. For that reason, when transcription is performed using the ink as it is, there is fear that the ink flows or weeping occurs. In order to prevent this phenomenon, moisture is made to absorb, so that the ink is made to become semiarid state ahead of time.

The pattern printed on the role paper 321 is transferred on the pad 331 to be the second transcription surface. A transcribing section 330 including the pad 331 is supported by 2 shafts and the screw rod 336. The screw rod 336 is rotated when power is transmitted to the screw rod 336 from the motor not shown. The transcribing section 330 shifts between the role paper 321 and two finger tip fixation means 50 by this rotation. In addition, the pad 331 performs up and down movement by a cylinder not shown. It should be noted that generally this transcribing section 330 is housed in the case 332, FIGS. 14 and 15 show the state.

The nail art pattern is printed on the role paper 321 by the ink jet printer 301. The pad 331 is made to shift above the role paper 321. The cylinder is made to drive during the predetermined time period, then the pad 331 is made to perform up and down movement so as to transcribe the ink on the role paper 321 to the pad 331 while coming into contact with the pad 331 to the printing surface of the role paper 321.

The ink is made to transcribe on the pad 331, then the pad 331 is made to shift above the fingertip fixation means 50. The pad 331 is made to perform up and down movement again upon driving the cylinder during predetermined time period again upper portion of the fingertip fixation means 50. By this means, it is possible to perform printing while causing the ink transcribed to the pad 331 to be performed re-transcription for the nail placed on the fingertip fixation means 50. After performing the printing in such away as above, the pad 331 is made to shift above the cleaning section 340 to perform cleaning of the pad 331. It is preferable to be used any of two cleaning section 340 provided corresponding to two fingertip fixation means 50.

The cleaning section 340 has approximately the same configuration and function as that shown in FIG. 9, and removes rubbishes, dusts adhered to the pad 331 or remaining ink on the pad 331. Also, the present apparatus is capable of being provided with the fare receiving apparatus similar to the above embodiment.

The printing of the art pattern for the nail of the user according to the above configuration is performed wholly in such a way as described later.

Firstly, the user selects picture or pattern of the art pattern and its color for printing to the nail from the samples of the nail art pattern indicated on surface panel of the apparatus or the samples indicated on presentation of the display of the touch panel apparatus 10. When the contents to print are determined, its art pattern number and color number are input from the touch panel apparatus 10. And then, the nail is set on the fingertip fixation means 50 while dropping the coin into the fare deceiving apparatus, the set OK button is made to press of the touch panel apparatus 10.

The control apparatus of the apparatus reads out the pattern data of the specified art pattern and the color data of coloration from-the memory. These data are set on the ink jet printer 301 so that the printing on the role paper 321 is performed. The role paper 321 is wound corresponding to predetermined length prior to the printing. New part of the role paper appears, therefore, the printing is performed on the new part.

When terminating the printing on the role paper 321, after prescribed time period, transcription printing according to the pad 31 is performed. Firstly, the transcription section 330 is sent to the role paper 321 on which the printing by the ink jet printer 301 is performed. At this position, the cylinder is made to drive during predetermined time period. By this means, the pad 331 is made to perform up and down movement on the role paper 321. The art pattern printed on the role paper 321 is made to transcribe on the pad 331. When terminating transcription of the art pattern for the pad 331, the transcription section 330 is sent on the fingertip fixation section 50. At this position, the cylinder is made to drive during predetermined time period again so as to perform up and down movement of the pad 331, so that the ink on the pad 331 is made to perform re-transcription on the nail. By this means, the printing of the nail art pattern is terminated.

In the present apparatus, two users are capable of accessing simultaneously the apparatus from both sides of the front surface and the rear surface. The pad 331 performs re-transcription printing for the nail of the one user. If necessary, it is possible to perform data input corresponding to another user or printing according to the ink jet printer 301.

It should be noted that when the ink is protruded from the nail and is adhered to part of the finger, it is possible to wipe the protruded ink by a cleaning swab with water. In addition, it is possible to prevent that the ink comes off upon applying topcoat on the nail when the nail art is terminated.

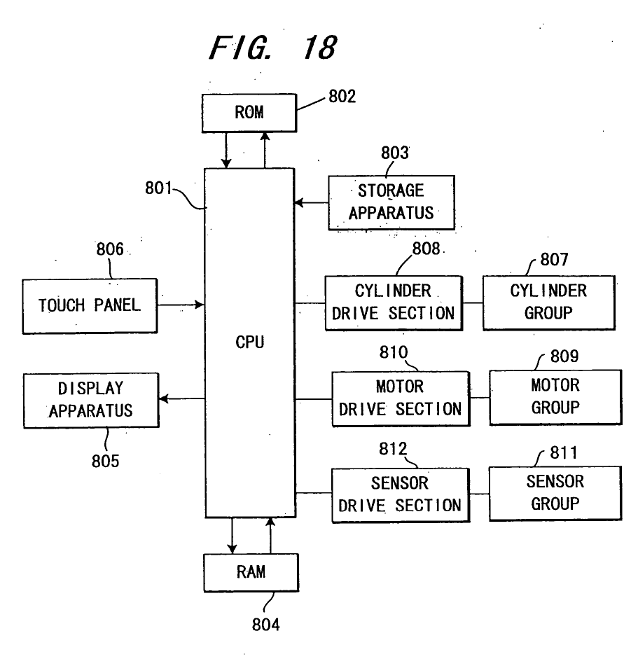

FIG. 18 is a circuit configuration view in common with respective embodiments of the nail art operating apparatus of the present invention described above.

The circuit of the present invention is comprised of, as shown in FIG. 18, a CPU (control apparatus) 801 for performing control of the whole apparatus, a ROM 802 storing program or various kinds of control data, a storage apparatus 803 such as a hard disk drive (HDD) for storing art pattern data or a floppy hard disk drive (FDD) or so forth, a RAM 804 which the CPU 81 uses for work, a display apparatus 805 for displaying information to be notified to the user, a touch panel 806 to be the input apparatus for performing various kind of instruction by the user, cylinder group 807 such as various kinds of cylinders or electromagnetic valves for driving them, a cylinder drive section 808 for driving its cylinder group 807, motor group 809 to be ones expressed while gathering above described various kinds of motors, a motor drive section 810 for driving various kinds of motors constituting its motor group 809, sensor group 811 to be ones presented while gathering various kinds of sensors, and a sensor drive section 812 for monitoring its output while driving various kinds of sensors constituting the sensor group 811. The CPU 801 follows instruction which the user performs via the touch panel 806. The CPU 801 controls the cylinder drive section 812 or the motor drive section 810 while observing output signal of various kinds of sensors sent from the sensor drive section 812. By this means, the above described operation is realized.

As described above, there is described the nail art operating apparatus of the present invention with the nail art operating apparatus as the example. The present invention is not limited to these ones. Within the limit with no deviation of the gist of the present invention, the present invention relates directly to the printing apparatus with various kinds of objects capable of performing printing to a solid body or special objects upon transcribing printing result according to the ink jet printer by using the pad printing apparatus. Further, the present invention is capable of adopting various correspondences.

For instance, in the first embodiment of the present invention, the explanation is that the selector table 120 is made to rotate, and it is possible to change plate surface 103 in use for printing upon changing the printing plate 102 to set to the selector table 120, however, it is preferable that change of the plate surface 103 is made to realize using another method. About the method for applying the ink to the plate surface 103 can be realized in the same way as above. Furthermore, it is possible to consider various kinds of methods concerning transmitting method of the printing plate 102 except for the present embodiments. In addition, there is provided the notch 105 on the periphery of the printing plate 102, and the notch is used for convenience at the time of transporting or positioning, however, when performing positioning simply and accurately, this notch 105 is necessarily no need. In addition, in this embodiment, the ink is of water-soluble one, it is good that the ink is of another type such as oily one. However, it is necessary for the squeegee 170 or the printing plate cleaning apparatus 200 to cope with the oily ink.

In the third embodiment of the present invention, the explanation is that the printing by the ink jet printer is performed on the role paper. However, it is possible to select surface of material with no capillarity at all as the first transcription surface upon selecting paint with a little moisture as kind of the ink. In this case, rough surface or smooth surface is selected as the surface of the material to be the first transcription surface in accordance with characteristic of the ink or kind of the pad. In addition, processing of the remaining ink because of incomplete transcription to the pad is that remaining ink is wiped by the adhesive cleaner, or remaining ink is washed away by washing water. In the case that remaining ink is washed away by the washing water, it is necessary for the ink to be dried until next operation is performed, therefore, it can be considered the countermeasure that polygonal annular one with a plurality of surfaces is made to rotate for natural seasoning in use for drying, drying method in which the ink is dried forcibly while blowing air, or drying method using both as the former and the later.

In addition, the explanation of the above described respective embodiments explains that the touch panel apparatus 10 is provided at right hand side of the fingertip fixation means 50, however, in the case that right fingers are made to perform the nail art, the operation is difficult to perform in this shape. It is also possible to provide two touch panel apparatuses 10 on either side of the fingertip fixation means 50 in order to facilitate the operation.

Moreover, the above explanation is about the nail art operating apparatus, however, the nail art operating method in use for the nail art operating apparatus is the subject of the present invention.

As described above the first and the second embodiments of the nail art operating apparatus of the present invention selects the ink of one ink container among the ink containers mounted on the container mounting means. The plate surface is made to select from a plurality of plate surface formation medium to be medium in which the plate surface is formed more than one placed on the placement stand. The selected ink is made to apply to the selected plate surface. The ink applied to the concave portion of this plate surface is made to transcribe on the pad once, after that, the nail art printing is performed in such a way that the ink is re-transcribed on the nail of the user. By this means, the user is capable of selecting desired one among various patterns, and enable the apparatus to print the pattern while selecting desired color among multiple colors during relatively short time period on the nail. Operation is simple and burden share to the user is small. On the occasion of the printing, noise or contamination of the operation surface is few. It is possible to realize the nail art operating apparatus which the user is capable of performing the nail art with enjoyment and the nail art operating method in use for the apparatus.

In addition, the third embodiment of the nail art operating apparatus of the present invention transcribes printed one on the first transcription surface temporary by the ink jet printing on the pad to be the second transcription surface, and then the transcribed one is made to perform re-transcription to final object thus the nail art printing is performed. By this means, the user is capable of printing desired one while selecting freely among multiple printing patterns and multiple colors, so that it is possible to print image on the nail without indistinct image, bleeding or pattern deformation. In addition, the printing is capable of performed during relatively short time period. Operation is simple and burden share to the user is small. On the occasion of the printing, noise or contamination of the operation surface is few. It is possible to realize the nail art operating apparatus which the user is capable of performing the nail art with enjoyment and the nail art operating method in use for the apparatus.

1. A nail art operating method comprising the steps of:
a fingertip fixation step for fixing the fingertip of the user on a pedestal; and
a printing step for printing a picture or a pattern by pad printing method on a nail of said fingertip fixed at said fingertip fixation step.

2. The nail art operating method according to claim 1, wherein, at said printing step, the printing is performed via plate surface selecting step for selecting the plate surface on which concave section corresponding to printed picture or pattern is formed, an ink applying step for applying ink to said plate surface selected at this plate surface selecting step, a transcribing step for transcribing said ink applied on said concave section of the plate surface on the pad as the transcription surface, and re-transcribing step for re-transcribing said ink transcribed on said pad for said nail at this transcribing step.

3. The nail art operating method according to claim 2, wherein, at the printing step, different pictures or patterns with different color inks are made to print on said nails upon repeating said plate surface selecting step and said ink applying step.

4. The nail art operating method according to claim 1, wherein said printing step further comprises the steps of:
an ink jet method applying step for spurting to apply the ink to a first transcription surface according to ink jet method printing;
a transcribing step for further transcribing the ink applied on said first transcription surface on the pad to be the second transcription surface at the ink jet method applying step; and
a re-transcribing step for further re-transcribing the ink transcribed on the pad for said nail at this transcribing step.

5. A nail art operating apparatus which applies an ink to a plate surface on which a concave section is formed, transcribes said ink existing on the concave section of this plate surface, and re-transcribes said ink transcribed on this pad for the nail comprising:
fingertip fixation means for fixing the fingertip of the user;
plate surface selecting means for selecting the plate surface in use from said plurality of plate surfaces;
ink applying means for applying the selected ink to the plate surface selected by said plate surface selecting means while selecting said ink introduced from a plurality of ink container for containing said ink; and
re-transcribing means for re-transcribing the ink transcribed on said pad for said nail so as to bring this pad into contact with the nail of the user's fingertip fixed on said fingertip fixation means, after transcribing the ink applied on said plate surface by said ink applying means to said pad.

6. The nail art operating apparatus according to claim 5, wherein said plate surface selecting means further comprises:
medium mounting means capable of mounting a plurality of plate surface formation medium to be the medium on which said plate surface is formed more than one; and
medium taking out means for taking out one plate surface formation medium from among said plate surface formation medium mounted on said medium mounting means,
wherein said ink applying means apply the selected ink introduced from said ink container to the plate surface on said plate surface formation medium taken out by said medium taking out means.

7. The nail art operating apparatus according to claim 6, wherein when said medium taking out means takes out said plate surface formation medium on which a plurality of said plate surfaces are formed, the printing for said nail is made to perform repeatedly while changing the plate surface used for the printing as needed depending on the taken out plate surface formation medium.

8. The nail art operating apparatus according to claim 6, wherein said plate surface formation medium including part to be of magnetic metal is shifted from said medium mounting means to a table for placing said plate surface formation medium by said medium taking out means, then part to be of said magnetic metal is attracted to be fixed by magnetic line of electromagnet on this table.

9. The nail art operating apparatus according to claim 6, wherein the dropping ink due to said ink applying means to said plate surface formation medium fixed on said table is applied by a squeegee.

10. The nail art operating apparatus according to claim 6, wherein common shifting means cause said medium taking out means and said re-transcribing means to shift.

11. The nail art operating apparatus according to claim 5, wherein the ink nozzle arrangement position shifts between the ink application position and the rest position on said table because said ink applying means rotates with its rotational axis section to become a fulcrum as the center.

12. The nail art operating apparatus according to claim 6, further comprising plate surface cleaning means for cleaning said plate surface formation medium after use.

13. The nail art operating apparatus according to claim 12, wherein said plate surface cleaning means and the rotational axis section of said ink applying means occupy identical position reciprocally against said table in use.

14. A nail art operating apparatus which transcribes an ink applied by an ink jet method printing to a pad, and re-transcribes said ink transcribed to this pad to a nail comprising:
fingertip fixation means for fixing the fingertip of the user;
ink jet method printing means for spurting to apply the ink to a first transcription surface depending on the ink jet method printing; and
re-transcribing means for re-transcribing the ink transcribed to said pad for said nail so as to bring this pad into contact with the nail of the fingertip of the user fixed on said fingertip fixation means, after transcribing the ink applied on said first transcription surface by this ink jet method printing means to said pad to be the second transcription surface.

15. The nail art operating apparatus according to claim 14, further comprising:
control means for controlling the apparatus; and storage means for storing a plurality of art pattern data and color data,
wherein said control means specify the printing to said ink jet method printing means based on said art pattern data and color data stored in said storage means.

16. The nail art operating apparatus according to claim 14, further comprising:
specification input means for specifying selection of said art pattern data and color data; and
display means for displaying a printed result pattern based on said art pattern data and color data selected by this specification input means.

17. The nail art operating apparatus according to claim 14, wherein said first transcription surface is a role paper with moisture-absorption characteristic and said second transcription surface is the pad.

18. The nail art operating apparatus according to claim 14, wherein said first transcription surface is of material with no capillarity, and said second transcription surface is the pad.

19. The nail art operating apparatus according to claim 5, wherein said fingertip fixation means is provided with nail position specification means for determining the position of the nail of said user.

20. The nail art operating apparatus according to claim 5, further comprising cleaning means for cleaning said pad.

21. The nail art operating apparatus according to claim 5, wherein there is provided accounting operation means causing the apparatus to operate in answer to receiving of coins or paper money or so forth.

22. The nail art operating apparatus according to claim 15, further comprising:
specification input means for specifying selection of said art pattern data and color data; and
display means for displaying a printed result pattern based on said art pattern data and color data selected by this specification input means.
